(19) United States
(12) Patent Application Publication
(10) Pub. No.: US 2012/0060500 A1
(43) Pub. Date: Mar. 15, 2012

(54) METHOD AND APPARATUS FOR COLLECTING SOLAR THERMAL ENERGY

(75) Inventor: Remus Nicolaescu, San Francisco, CA (US)

(73) Assignee: ACCENDO ADVISORS, LLC, San Francisco, CA (US)

(21) Appl. No.: 13/232,842

(22) Filed: Sep. 14, 2011

Related U.S. Application Data
(60) Provisional application No. 61/383,226, filed on Sep. 15, 2010.

(51) Int. Cl. F03G 6/00; F24J 2/04; F24J 2/20; F24J 2/48

(52) U.S. Cl. 60/641.8; 126/674; 126/676; 126/642; 126/646; 126/574

(57) ABSTRACT

A solar thermal panel is disclosed. An example evacuated flat solar thermal panel includes a first evacuated cavity enclosed between first and second layers of material. A second evacuated cavity is enclosed between third and fourth layers of material. A high temperature working fluid cavity is enclosed between the second and third layers of material. A plurality of pillars are disposed between the first and second layers of material, and disposed between the third and fourth layers of material.

### REFERENCE TO PRIOR APPLICATION(S)

This application claims the benefit of U.S. Provisional Application No. 61/383,226, filed Sep. 15, 2010, entitled “METHOD AND APPARATUS FOR COLLECTING SOLAR THERMAL ENERGY.”

### BACKGROUND INFORMATION

1. Field of the Disclosure

The present invention relates generally to solar energy, and more specifically, the invention relates to collecting solar thermal energy.

2. Background

Solar thermal collectors are devices that collect solar energy by converting sunlight into heat through the use of a radiation absorber. There are a variety of types of solar thermal collectors. In general, the different types of solar thermal collectors can be categorized based on their design and the temperature of the working fluid.

One type of solar thermal collector is a flat panel collector. A flat panel collector is a collector with a flat shape/topology that is placed in the sun to absorb solar radiation and a fluid that is transported through the flat panel collector is heated as a result of the absorption of the sunlight. In general, as the losses of the flat panel collectors are relatively high, the fluid that is transported through a flat panel collector is heated to temperatures up to approximately 100° C.

Another type of solar thermal collector is an evacuated tube collector. An evacuated tube collector is similar to a flat panel collector in that it is placed in the sun to absorb sunlight and a fluid that is transported through the collector is heated as a result of the absorption of the sunlight. However, in evacuated tube collectors, the tube through which the fluid is transported is surrounded by vacuum and the collector has a cylindrical shape. As a result, the loss of heat to the outside from the tube due to convection or conduction is greatly reduced. In general, the fluid that is transported through an evacuated tube collector can be heated to temperatures of up to approximately 150° C.

Other types of solar thermal collectors include parabolic trough collectors and Fresnel collectors. These types of solar thermal collectors include structures that concentrate or focus the solar radiation onto an element that is utilized to heat the fluid that is transported through the solar thermal collector. By concentrating solar radiation, the fluid that is transported through the solar thermal collector can be heated to temperatures in excess of 150° C. However, in order for these concentrating structures to be effective, the parabolic trough collectors and Fresnel collectors require one or two axis tracking structures to track the sun as it travels across the sky and adjust the focus of the concentrating structures accordingly.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows a cross section illustration of an example low loss flat evacuated solar thermal panel in accordance with the teachings of the present invention.

FIG. 2 shows a cross section illustration of another example low loss flat evacuated solar thermal panel in accordance with the teachings of the present invention.

FIG. 3 shows cross section illustrations of an example low loss flat evacuated solar thermal panel including an example manifold structure in accordance with the teachings of the present invention.

FIG. 4 shows an example arrangement of a plurality of example low loss flat evacuated solar thermal panels connected to one another in accordance with the teachings of the present invention.

FIG. 5 shows a block diagram of an example system that includes one or more example low loss flat evacuated solar thermal panels in accordance with the teachings of the present invention.

FIG. 6 shows a block diagram of example processing included in an example system that includes one or more example low loss flat evacuated solar thermal panels in accordance with the teachings of the present invention.

FIG. 7 shows an example chart illustrating example curves of calculated collector loss profiles as a function of temperature of operation in accordance with the teachings of the present invention.

### DETAILED DESCRIPTION

Examples related to low thermal loss, high temperature, monolithic flat evacuated solar thermal panels in accordance with the present invention are disclosed. In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment,” “an embodiment,” “one example” or “an example” means that a particular feature, structure or characteristic described in connection with the embodiment is included in at least one embodiment or example of the present invention. Thus, the appearances of the phrases “in one embodiment,” “in an embodiment,” “in one example” or “in an example” in various places throughout this specification are not necessarily all referring to the same embodiment. The particular features, structures or characteristics may be combined for example into any suitable combinations and/or sub-combinations in one or more embodiments or examples. Furthermore, it is appreciated that the figures provided herewith are for explanation purposes to persons ordinarily skilled in the art and that the drawings are not necessarily drawn to scale.

As will be discussed, examples according to the teachings of the present invention include methods and apparatuses for a monolithic, evacuated flat panel collector that does not require a tracking mechanism and is able to operate/heat the working fluid at temperatures in excess of 150° C. under average incident solar radiation conditions. As will be discussed, examples of the disclosed collector have the ability to provide heated steam at temperatures of at least 150-250° C. and can be integrated into a building to provide the building with a combined heating, power generation and cooling solution.

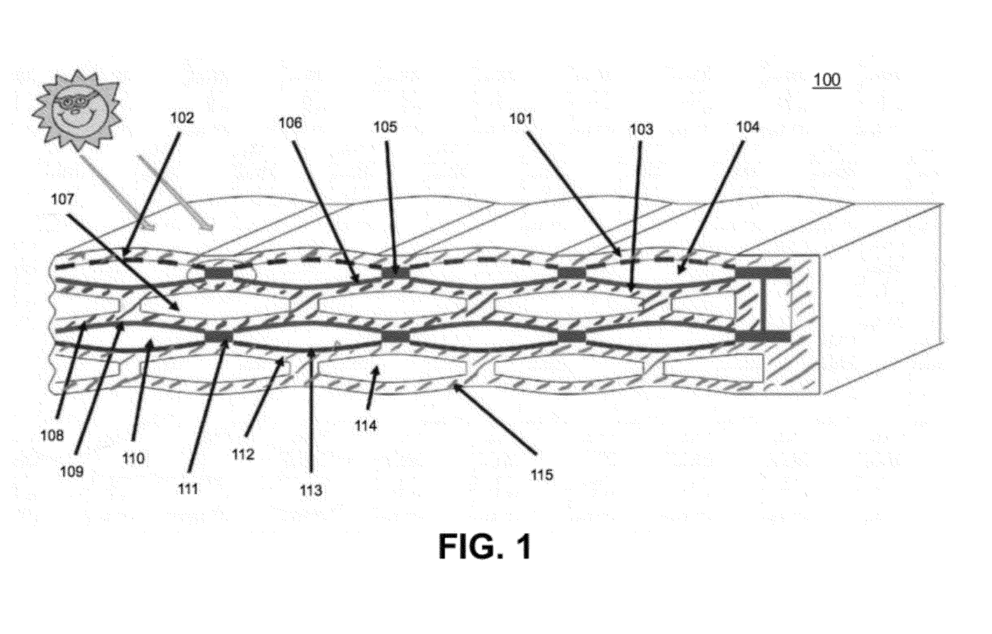

To illustrate, FIG. 1 shows a cross section of one example of low loss flat evacuated solar thermal panel 100 in accordance with the teachings of the present invention. As shown in the illustrated example, the solar thermal panel 100 includes five layers, which include first layer 101, second layer 103, third layer 108, fourth layer 112 and an optional fifth layer 115. In one example, the first, second, third, fourth and optional fifth layers 101, 103, 108, 112 and 115 are made of a material such as glass or other suitable materials including for example tailored glass compositions, such as boron doped glass or a polymer able to operate at temperatures in excess of 100 degrees Celsius such as PTFE (i.e. polytetrafluoroethylene) or ETFE (i.e. ethylene/tetrafluoroethylene copolymer) or a transparent to light polymer able to operate at temperatures in excess of 100 degrees Celsius. In another example, first, fourth and fifth layers 101, 112 and 115 are made of glass, while second and third layers 103 and 108 are made of copper or other suitable material. In one example, a first evacuated cavity 104 is enclosed between the first layer 101 and second layer 103. A second evacuated cavity 110 is enclosed between the third layer 108 and fourth layer 112. As shown in the example, the second layer 103 and third layer 108 enclose a high temperature working fluid cavity 107 through which a working fluid is to flow. In one example, an optional climate control cavity 114 may be included between the fourth layer 112 and optional fifth layer 115. In one example, pillars 105 are disposed between first and second layers 101 and 103, and pillars 111 are disposed between third and fourth layers 108 and 112 as shown.

In operation, solar radiation is incident on a top surface of the solar thermal panel 100 and passes through the first layer 101, through the first evacuated cavity 104 and then gets absorbed by a coated second layer 103. In one example, second layer 103 is coated with a coating 106, which in one example is a high absorption, low emissivity coating. As mentioned above, the second and third layers 103 and 108 enclose the high temperature working fluid cavity 107 that contains the working fluid. In operation, heat is transferred to the working fluid that is circulated through the high temperature working fluid cavity 107.

In one example, the working fluid is pumped out of the high temperature working fluid cavity 107 to a heat to power conversion unit and heated fluid storage units. The first and second evacuated cavities 104 and 110 defined on the opposing sides of the high temperature working fluid cavity 107 minimize the conduction and convection thermal losses of heat in the working fluid to the environment.

In one example, a coating 106 having high absorption in the visible spectrum and low infrared emissivity is applied to second layer 103 to reduce the thermal losses to the environment due to radiative transfer. In one example, a coating 113 is applied to layer 112 to reflect back infrared radiation emitted by the high temperature working fluid cavity 107 to further reduce losses though the back side of solar thermal panel 100. As shown in the depicted example, layer 101 is coated with a coating 102 that in one example is a dichroic coating, which has high transmission in the visible and high reflectivity in the mid to far infra red spectrum. In addition, coating 102 further reduces radiative losses from the high temperature working fluid cavity 107 and surrounding structure as well by partially reflecting back the infrared radiation emitted by the high temperature working fluid cavity 107.

In one example, the chemical composition of layers 103 and 108, which enclose the high temperature working fluid cavity 107 and the high temperature working fluid is optimized to maximize absorption of infrared radiation in excess of 2 microns. In one example, pillars 105 and 111 are silica aerogel pillars. In an evacuated atmosphere in the first and second evacuated cavities 104 and 110, pillars 105 and 111 provide mechanical structural integrity to the solar thermal panel 100 while minimizing conduction and convection losses.

In one example, first layer 101 is an outdoor facing layer and is transparent to solar radiation and has the required mechanical integrity to support large pressure gradients. In one example, the material used for creating the structure of first layer 101 could be SiO2 silica glass, although other materials and glass compositions can be used.

As mentioned above, coating 102 in one example is a dichroic coating, which has high transmission in the visible part of the spectrum, high reflectivity in the mid and far infrared part of the solar spectrum for wavelengths in excess of 2 microns.

In one example, second layer 103 is made of transparent or opaque material with the required mechanical integrity to support large pressure gradients, high temperatures and has high absorption for radiation with wavelength in excess of 2 microns. In one example, the material used for creating the structure of second layer 103 could be SiO2 silica glass, although other materials or tailored glass compositions, such as boron doped glass or a polymer able to operate at temperatures in excess of 100 degrees Celsius such as PTFE (i.e. polytetrafluoroethylene) or ETFE (i.e. ethylene/tetrafluoroethylene copolymer) can be used.

In one example, the first evacuated cavity 104 defined between first and second layers 101 and 103 reduces heat transfer between cold first layer 101 and hot second layer 103.

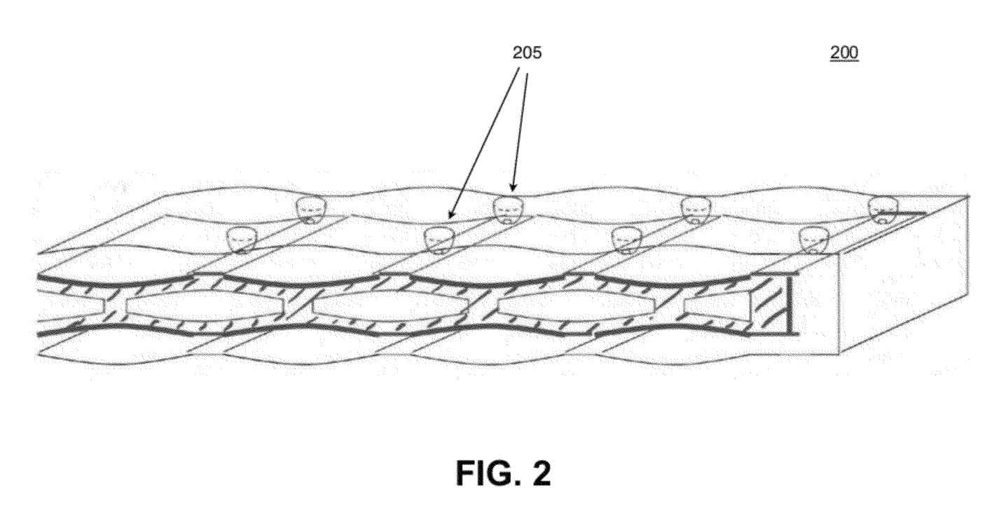

In one example, pillars 105 are made of high strength, very low thermal conductivity material. In one example, pillars 105 are silica aerogel pillars having a density designed to achieve a combination of optimal strength and thermal conductivity. In one example, the silica aerogel is reinforced with additional compounds and other materials with similar properties can be used. Pillars 105 can be transparent, opaque, have spatial transparency gradients or dichroic properties. In one example, the geometric shape of pillars 105 can be designed to achieve optimal structural, thermal, and optical properties. In one example, the pillars 105 can be rectangular running for the width of the solar thermal panel 100 as shown in FIG. 1. In another example, the pillars 105 may be hemispheres with a cut top as will be shown below in FIG. 2. It is appreciated of course that these geometries are provided for explanation purposes and that pillars 105 may be other shapes or configurations in accordance with the teachings of the present invention.

In one example, coating 106 is a high temperature, high absorption for the solar spectrum and very low infrared emissivity coating. In one example, coating 106 may be a cermet, ceramic metal coating. In another example, coating 106 may be a silver based ceramic metal coating with high absorption coefficient for solar radiation wavelengths of less than 2-3 microns, and with a low emissivity coefficient for infrared radiation wavelengths of greater than 2-3 microns.

As discussed above, high temperature working fluid cavity 107 contains heat transfer/working fluid. In one example, the working fluid used can be water vapor. In other examples, it is appreciated of course that other fluids can be used for working fluid in the high temperature working fluid cavity 107.

In one example, third layer 108 is made of transparent or opaque material with the required mechanical integrity to support large pressure gradients, high temperatures and has high absorption for radiation with wavelength in excess of 2 microns. In one example, the material used for creating the structure of third layer 108 could be SiO2 silica glass, although other materials or tailored glass compositions can be used.

In one example, an optional coating 109 may be included on third layer 108 as shown. In one example, coating 109 is a high temperature, high absorption coating for the solar spectrum and a very low infrared emissivity coating. In one embodiment coating 109 may be a cermet, ceramic metal coating. In another example, coating 109 may be silver based ceramic metal coating with high absorption coefficient for solar radiation wavelengths of less than 2-3 microns, and with a low emissivity coefficient for infrared radiation wavelengths of greater than 2-3 microns.

In one example, evacuated cavity 110 defined between third and fourth layers 108 and 112 reduces heat transfer between hot third layer 108 and cold fourth layer 112.

In one example, pillars 111 are made of high strength, very low thermal conductivity material. In one example, pillars 111 are silica aerogel pillars having a density designed to achieve a combination of optimal strength and thermal conductivity. In one example, the silica aerogel is reinforced with additional compounds and other materials with similar properties can be used. Pillars 111 can be transparent, opaque, have spatial transparency gradients or dichroic properties. In one example, the geometric shape of pillars 111 can be designed to achieve optimal structural, thermal, and optical properties. In one example, the pillars 111 can be rectangular running for the width of the panel as shown in FIG. 1. In another example, the pillars 111 can be hemispheres with a cut top as will be shown below in FIG. 2. It is appreciated of course that these geometries are provided for explanation purposes and that pillars 105 may be other shapes or configurations in accordance with the teachings of the present invention.

In one example, fourth layer 112 is made of a transparent or opaque material with the required mechanical integrity to support large pressure gradients, high temperatures and has high absorption for radiation with wavelength in excess of 2 microns. In one example, the material used for creating the structure of fourth layer 112 could be SiO2 silica glass, although other materials or glass compositions can be used.

In one example, coating 113 is a broadband high reflectivity coating covering the visible and infrared parts of the electromagnetic radiation spectrum. In one example, coating 113 is designed to have peak reflectivity in the mid to far infrared sections of the spectrum.

In one example, an optional climate control cavity 114 is included between fourth layer 112 and optional fifth layer 115 as discussed above. In one example, climate control cavity 114 contains circulating heating or cooling fluid intended to provide thermal control of the housing unit for which the solar thermal collector 100 serves as a roof/wall.

In one example, an optional fifth layer 115 is made of opaque or transparent material exhibiting high thermal conductivity. In different examples, fifth layer 115 and climate control 114 may or may not be present in solar thermal collector 100.

FIG. 2 shows a cross section of another example of low loss evacuated solar thermal panel 200 in accordance with the teachings of the present invention. It is appreciated that the example solar thermal panel 200 illustrated in FIG. 2 shares many similarities with example solar thermal panel 100 illustrated in FIG. 1. As mentioned previously, one difference between example solar thermal panel 200 of FIG. 2 and example solar thermal panel 100 of FIG. 1 is that example solar thermal panel 200 includes pillars 205 instead of pillars 105 and 111. In one example, pillars 205 are hemispheres with a cut top as shown in FIG. 2 instead of rectangular pillars 105 and 111 running for the width of the panel as shown in FIG. 1.

In one example, pillars 205 are hemispherical silica aerogel structures that reduce the material cross section through which conductive heat transfer can occur between first and second layers 101 and 103 and between third and fourth layers 108 and 112. Pillars 205 can also eliminate any non-compressive forces on the support structure. In one example, pillars 205 can be positioned every 5 cm in both horizontal directions and have a hemisphere radius of 5 mm and a radius at contact to the hot second and third layers 103 and 108 of 3 mm.

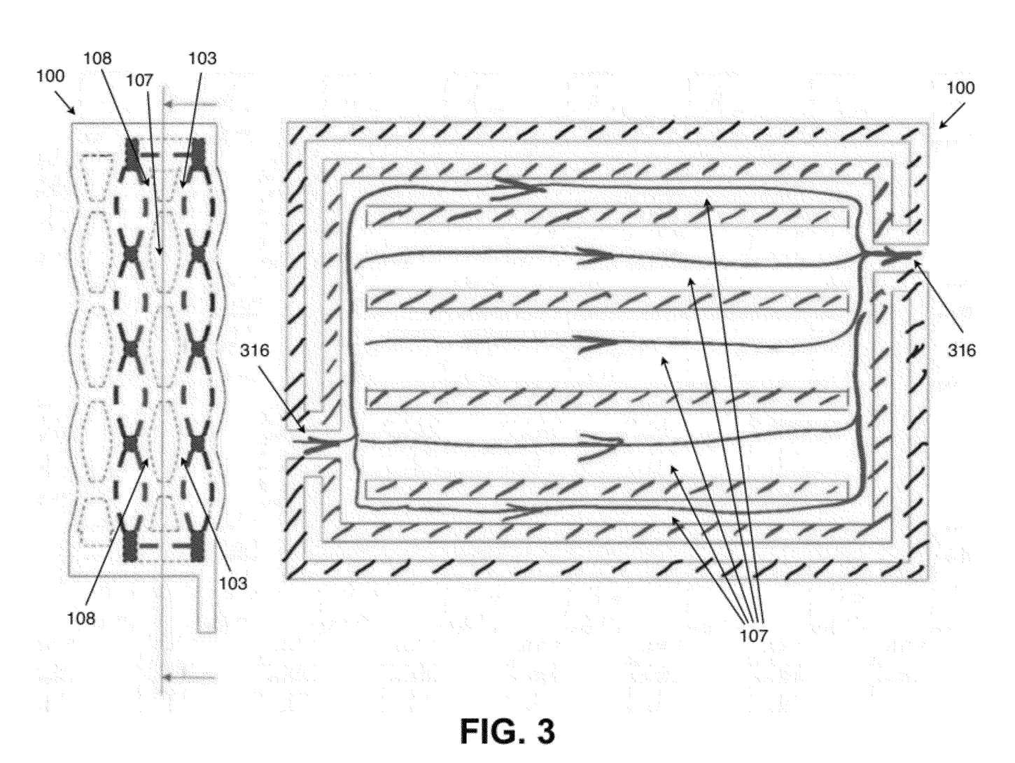

FIG. 3 shows two cross-section illustrations of example solar thermal panel 100 with a working fluid cavity 107 having an example manifold structure. As can be observed, the cross-section illustration of solar thermal panel 100 on the left hand side of FIG. 3 is similar to the cross-section illustration of solar thermal panel 100 shown in FIG. 1. The cross-section illustration of solar thermal panel 100 on the right hand side of FIG. 3 is a cross-section of solar thermal panel 100 through the high temperature working fluid cavity 107. As shown in the cross-section of solar thermal panel 100 on the right hand side of FIG. 3, working fluid 316 in one example enters the manifold structure of high temperature working fluid cavity 107 of solar thermal panel 100 on the left hand side. In operation, the working fluid 316 is heated as it is transported through high temperature working fluid cavity 107 as a result of the absorbed solar radiation and heat transfer from contact to the hot walls of the high temperature working fluid 107. When working fluid 316 exits the high temperature working fluid cavity 107 on the right hand side, the working fluid 316 is hot. In another example, the cavity 107 can be designed so that the working fluid 316 has a meandering path (instead of the path through the example manifold structure shown in FIG. 3) from entry to exit of the high temperature working fluid cavity 107.

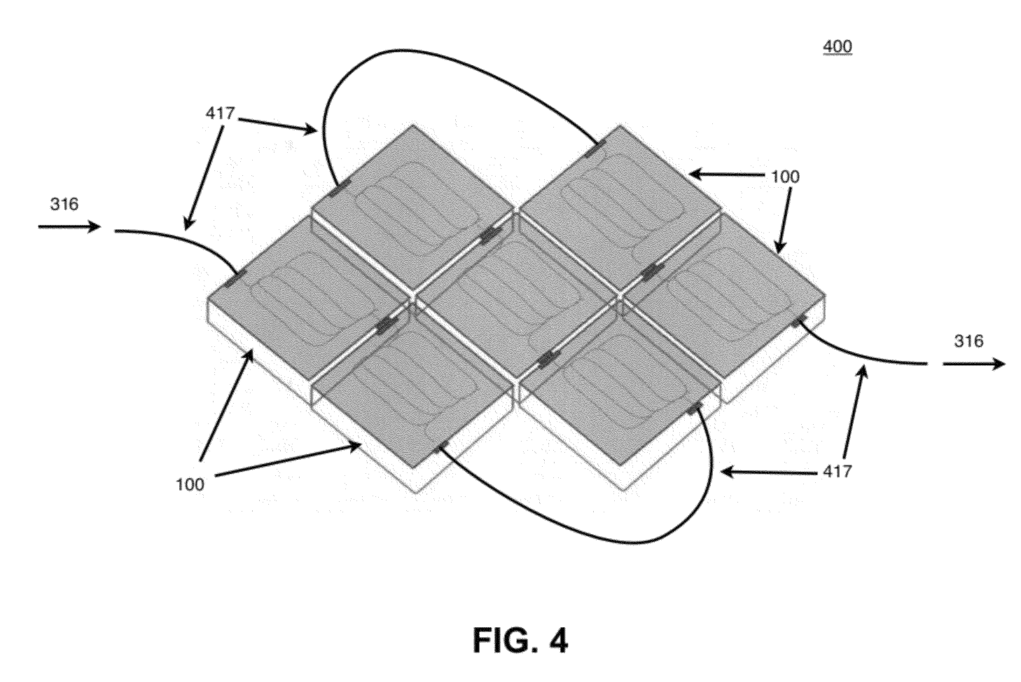

FIG. 4 shows an illustration which shows an example in which a plurality of individual solar thermal panels 100 are connected to one another to form an assembly 400 of solar thermal panels 100. As can be observed in the illustrated example, solar thermal panels 100 may be constructed as modules, which can be interconnected to work together to build assembly 400 having a variety of shapes, sizes and configurations. As such, a large assembly 400 can be constructed for integration into a roof of a building or a smaller assembly 400 can be constructed for integration into a portion of a wall.

As shown in the illustrated example, the plurality of solar thermal panels 100 may be directly connected to one another, or may be connected to one another by tubing 417. In operation, cold working fluid 316 can be pumped into assembly 400 through tubing 417 as shown on the left hand side of FIG. 4. As working fluid 316 is transported through each of the individual solar thermal panels 100, working fluid 316 is heated until hot working fluid 316 exits assembly 400 from tubing 417 on the right hand side of FIG. 4.

As mentioned above, with solar thermal panel 100 constructed as modules that can be configured as assemblies 400 as shown in FIG. 4, it is appreciated that solar thermal panel 100 can be integrated roofs and walls of buildings to provide integrated systems for power generation, heating, cooling and hot water for the building. In one example, the working fluid 316 heated by solar radiation in solar thermal panels 100 is transported and used as a high temperature source for a heat to electrical power conversion unit situated adjacent to or nearby the solar thermal panel 100. In one example, the power conversion unit used to convert heat into electricity can be a Stirling engine or a steam turbine. In one example, the heat to electrical power conversion unit generates electricity to be used in the residential unit.

In one example, residual high temperature working fluid 316 may be stored and (a) used to provide heat for the home; (b) used for air conditioning through a heat driven cooling unit; and (c) used for hot water appliances. In one example, a single or double effect steam powered absorption chiller can be used for air conditioning. In one example, the hot water appliance can utilize the cooling water used to maintain the constant temperature of the cold side of a Stirling engine in the range of 290 to 330 ° K. used for residential hot water. The excess heat from the working fluid 316 used to heat the hot side of the Stirling engine is transferred to a heat reservoir.

In one example, optimal distribution between the different types of uses of electricity, space heating, cooling, and/or hot water, is dynamically adjusted based on the specific demand conditions at the location and time of conversion. For example, a system in a warmer southern location in the summer will allocate more energy use for cooling, hot water and electricity with little or no energy use for space heating. In contrast, a system in winter in a northern area will use more energy in the space heating and hot water component while no cooling will be needed and electricity conversion would be on a best effort basis. Once the optimal distribution of collected energy is established, the system operating parameters are adjusted to maximize conversion efficiency for the specific mix required by the demand conditions.

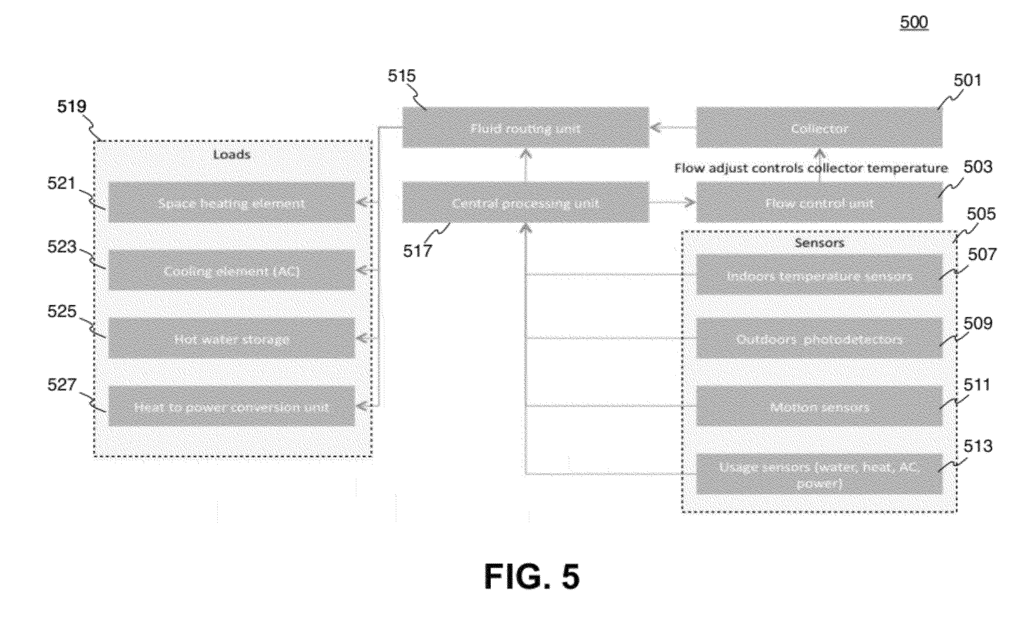

FIG. 5 is an illustration of a block diagram of one example of such a system 500 that includes evacuated solar thermal panels 100 in accordance with the teachings of the present invention. In the depicted example, one or more evacuated solar thermal panels are shown collectively in FIG. 5 as collector array 501. As shown, a flow control unit 503 coupled to collector array 501 adjusts the flow of working fluid through collector array 501 to control the collector temperature. The working fluid flows from collector array 501 to fluid routing unit 515. In one example, the fluid routing unit routes the working fluid to loads 519, which may include one or more of a spaced heating element 521, a cooling element 523 (e.g. air conditioning), hot water storage 525 and/or a heat to power conversion unit 527. As shown in the depicted example, fluid control unit 503 and fluid routing unit 515 are both coupled to be controlled by a central processing unit 517. In one example, central processing unit 517 receives input information from an array of sensors 505. In one example, the array of sensors 505 may include one or more of indoor temperature sensors 507, outdoor photodetectors 509, motion sensors 511 and/or usage sensors 513. In one example, usages sensors 513 may include any combination of water usage sensors, heat usage sensors, air conditioning usage sensors, or the like.

In one example, system 500 is an integrated system that is fully configurable to maximize the conversion efficiency of the system, defined as a percentage of total energy demand of the unit supplied by system 500, by continuously adjusting certain operating parameters. As shown in the example depicted in FIG. 5, operation of system 500 is based on central processing unit 517. In one example, central processing unit 517 may include a microcontroller or a digital signal processor with a suitable amount of memory. In the illustrated example, the array of sensors 505 provides central processing unit 517 with real time information regarding indoor and outdoor parameters. In one example, the indoor parameters provided by the array of sensors 505 include temperature, humidity, and/or the number of occupants of the unit at any given moment. In one example, the outdoor parameters provided by the array of sensors 505 include the solar radiation incident on collector array 501 and/or the outside temperature.

In one example, central processing unit 517 is coupled to control the flow and temperature of the working fluid through collector array 501 based on input solar radiation conditions and demand patterns as provided from the array of sensors 505 to maximize conversion efficiency of the system 500 and useable energy. For example, a system 500 operating in winter with low ambient temperatures in overcast conditions would have a low level of incident solar radiation, such as for example on the order of approximately 100-200 W/m2. In this situation, example system 500 maximizes its overall conversion efficiency by using most of the heat output of collector array 501 as energy supply for space heating element 521. As space heating does not require elevated temperatures, efficiency can be maximized by reducing the operating temperature from 200° C. to 100° C. of the working fluid through collector array 501 to reduce radiative loss, even if electricity generation by heat to power conversion unit 527 would be impaired. In addition, the array of sensors 505 throughout the home coupled with electronic control would further optimize parameters range for optimum efficiency. Examples of parameters to be taken into account include preset comfort levels, electricity pricing, storage efficiency, and the like. Excess heat stored in the heat reservoir can be used for heating needs or transformed in electricity during the times when no direct solar radiation is available, such as for example during night time or during periods of cloudy weather.

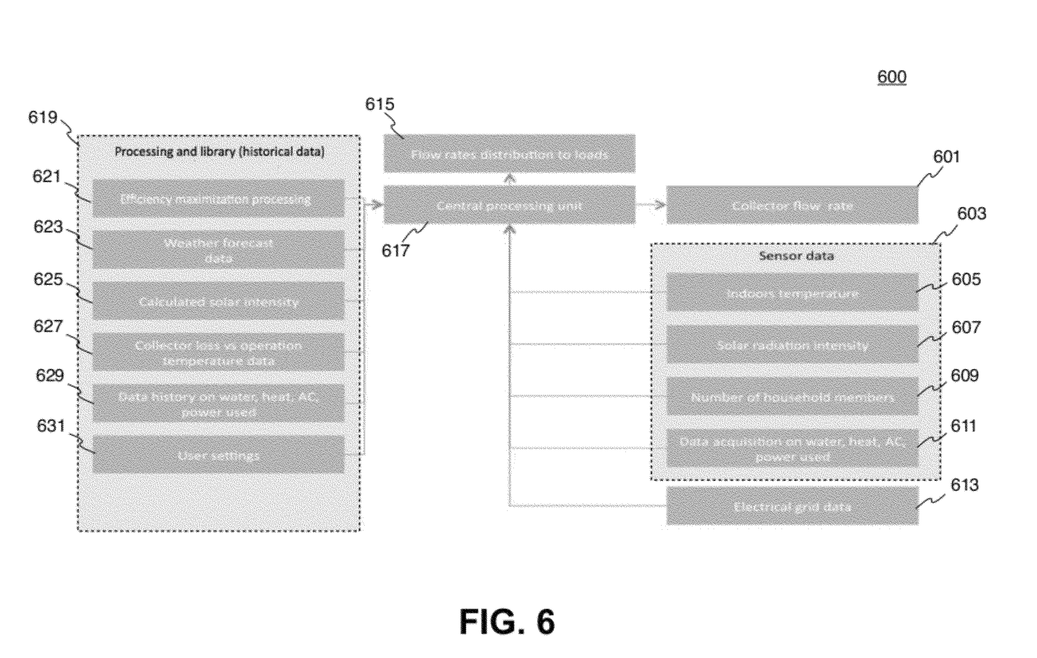

FIG. 6 shows a block diagram of example processing included in an example system that includes one or more example low loss evacuated solar thermal panels in accordance with the teachings of the present invention. As shown in the depicted illustration, example system 600 includes a central processing unit 617, receives sensor data 603 and electrical grid data 613, and utilizes processing and library 619, which includes historical data, to optimize for maximum system efficiency, defined as percentage of total energy demand of the unit supplied by system 500, when calculating desired operation parameters for collector flow rate 601 of the energy from the collector array, and when calculating the flow rate distribution to loads 615.

As will be discussed in greater detail below, the processing and library 619 utilized by central processing unit 617 includes one or more of energy maximization processing 621, weather forecast data 623, calculated solar intensity 625, collector loss vs. operation temperature data 627, data history on water, heat, air conditioning power used 629 and user settings 631. In addition, the sensor data 603 received by central processing unit 617 includes one or more of indoor temperature 605, solar radiation intensity 607, number of household members 609 and data acquisition on water, heat and air conditioning power used 611.

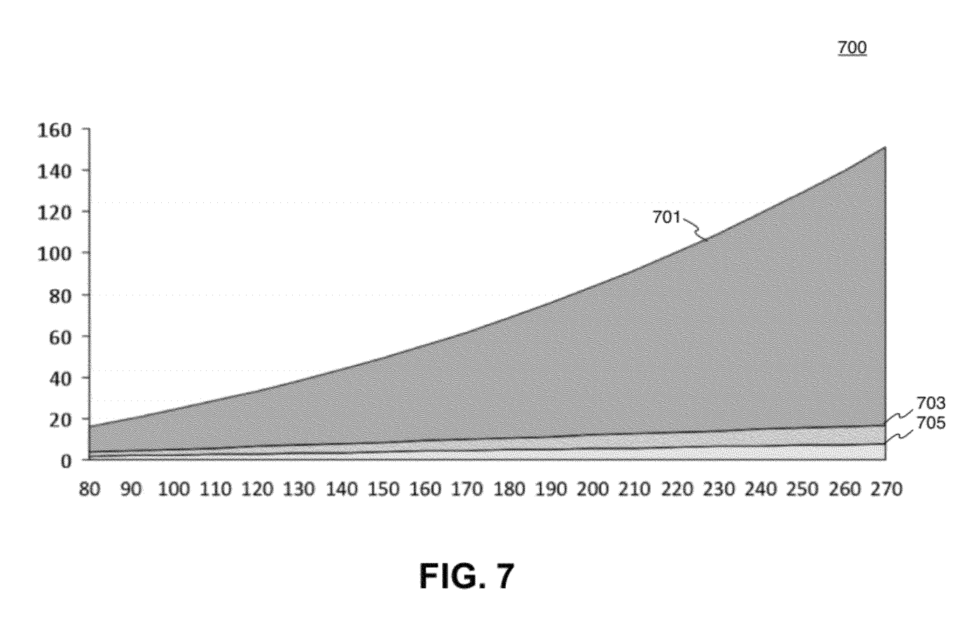

In particular, one example of the efficiency maximization processing 621 utilized by the central processing unit 617 calculates collector array temperature of operation and flow rates and distribution of collected heat to the loads to maximize system efficiency, defined as percentage of total energy demand of the unit supplied by system 500. In one example, the weather forecast data 623 includes short/medium term weather data provided by local weather services. The calculated solar intensity 625 includes theoretical solar flux data for the location and time of the year without taking into account weather. In one example, weather information may also be added based on the weather forecast data and real time data. Collector loss vs. operation temperature data 627 may include specified loss curves for the collector, such as for example the loss curves illustrated and described in greater detail below with respect to FIG. 7. Data history on water, heat, air conditioning power used 629 data may include data collected over time by the array of sensors that is used to establish time based usage patterns specific to the household.

In one example, indoor temperature sensors 605 measure real time indoor temperatures. Solar radiation intensity sensors 607 include photodetectors that measure real time flux of incident radiation incident on the collector array. In one example, number of household members sensors 609 include motion sensors to detect the number of members of the household present and location to determine hot water and/or heating needs.

In operation, in order to achieve maximum overall efficiency of system 600, one example of central processing unit 617 utilizes several categories of data including real time input sensor data 603 from an array of sensors measuring the indoor and outdoor related parameters. Examples of indoor related parameters include indoor temperature data 605 such as air temperature data that is compared to the set/desired temperature, humidity, number of household members 609 or the number of occupants present in the unit at any time. Outdoors related parameters received by the central processing unit 617 include supply data such as solar radiation intensity 607 or solar energy flux on the collector, outdoor temperature, etc.

In one example, central processing unit 617 also receives historical data from processing and library 619 on energy usage and type of energy, such as thermal and/or electrical, and time and location dependent weather patterns. In one example, usage data collected by the sensors is stored to be used by central processing unit 617 to determine usage patterns and optimize the operation of the system 600. In one example, medium term weather forecast data 623 may be provided to central processing unit 617 from external sources, such as for example public weather services. In one example, central processing unit 617 also utilizes electrical grid data 613, such as for example grid loading at particular times that can be used to decide on the priority for conversion of the collected energy into electricity.

As mentioned above, in order to maximize efficiency, one example of central processing unit 617 also considers calculated collector loss profiles as a function of temperature of operation, examples of which are illustrated in the example curves shown in the graph FIG. 7. In particular, curve 701 of FIG. 7 shows an example of normalized loss for the collector (W/m2) versus temperature of operation of the working fluid (° C.) for aggregate loss (including radiative, conductive/convective and junction loss). Curve 703 shows an example of normalized loss for the versus temperature of operation of the working fluid for conductive/convective loss, while curve 705 shows an example of normalized loss for the versus temperature of operation of the working fluid for junction loss. By comparing the input normalized energy flux on the collector array with the normalized loss at set operation temperature, optimal parameters of operation for the collector array can be determined. For example if the incident radiation is in the range of 180 W/m2, a collector operating at 250° C. will have an efficiency of less than 30% (180-130)/180 while operating at 100° C. the efficiency will be over 80% (180-30)/180).

In summary, referring back to FIG. 5, based on the input data discussed above, one example of the central processing unit 517 calculates the optimal temperature of operation for the collector array 501/working fluid and the fluid flow required to achieve the desired temperature. The central processing unit 517 output is provided to a flow control unit 503 to adjust the flow of the working fluid to adjust the collector temperature. In addition, a second parameter that is calculated by the central processing unit 517 is provided to a fluid routing unit 515 to control the distribution of the collected energy to the different loads in loads 519, including for example, space heating element 521, cooling element 523, hot water storage 525 and heat to power conversion unit 527.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific temperatures, mechanical parameters, voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. An evacuated flat solar thermal panel, comprising:
a first evacuated cavity enclosed between first and second layers of material;
a second evacuated cavity enclosed between third and fourth layers of material;
a high temperature working fluid cavity enclosed between the second and third layers of material; and
a plurality of pillars disposed between the first and second layers of material, and disposed between the third and fourth layers of material.

2. The evacuated flat solar thermal panel of claim 1 wherein the plurality of pillars comprise silica aerogel.

3. The evacuated flat solar thermal panel of claim 1 wherein the second and third layers comprise glass.

4. The evacuated flat solar thermal panel of claim 1 wherein the second and third layers comprise a tailored glass composition.

5. The evacuated flat solar thermal panel of claim 1 wherein the second and third layers comprise boron doped glass.

6. The evacuated flat solar thermal panel of claim 1 wherein the second and third layers comprise a polymer able to operate at temperatures in excess of 100 degrees Celsius.

7. The evacuated flat solar thermal panel of claim 1 wherein the second and third layers comprise polytetrafluoroethylene.

8. The evacuated flat solar thermal panel of claim 1 wherein the second and third layers comprise ethylene/tetrafluoroethylene copolymer.

9. The evacuated flat solar thermal panel of claim 1 wherein the first and fourth layers comprise glass.

10. The evacuated flat solar thermal panel of claim 1 wherein the first and fourth layers comprise a tailored glass composition.

11. The evacuated flat solar thermal panel of claim 1 wherein the first and fourth layers comprise boron doped glass

12. The evacuated flat solar thermal panel of claim 1 wherein the first and fourth layers comprise a transparent to light polymer able to operate at temperatures in excess of 100 degrees Celsius.

13. An energy harvesting system, comprising:
an interconnected array of evacuated flat solar thermal panels, wherein each of the evacuated flat solar thermal panels comprises:
a first evacuated cavity enclosed between first and second layers of material;
a second evacuated cavity enclosed between third and fourth layers of material;
a high temperature working fluid cavity enclosed between the second and third layers of material; and
a plurality of pillars disposed between the first and second layers of material, and disposed between the third and fourth layers of material;
a heat reservoir connected to the interconnected array of evacuated flat solar thermal panels, wherein a thermally conductive material is transferred between the interconnected array of evacuated flat solar thermal panels and the heat reservoir to transfer heat collected in the interconnected array of evacuated flat solar thermal panels to the heat reservoir; and
a plurality of valves and pumps connected to the interconnected array of evacuated flat solar thermal panels and the heat reservoir to control the flow of the thermally conductive material.

14. The energy harvesting system of claim 13 wherein the thermally conductive material comprises a high temperature working fluid.

15. The energy harvesting system of claim 13 wherein the energy harvesting system is integrated into a building.

16. An energy conversion system, comprising:
a heat to power conversion unit to convert thermal energy of a high temperature fluid into electricity;
a space heating element connected to a heated fluid storage unit to provide heating;
a heat driven cooling element connected to the heated fluid storage unit to provide refrigerated fluid to provide cooling;
an array of sensors distributed indoor and outdoor to measure system parameters and collect system and environmental data;
a central processing unit coupled to the array of sensors to process data from the array of sensors, electrical grid data from a utilities operator and data history on water, heat, and power used to calculate operation parameters for components of the energy conversion system; and
a memory unit coupled to the central processing unit to store processing instructions to be executed by the central processing unit and to store the data history on water, heat, and power used.

17. The energy conversion system of claim 16 wherein the heat to power conversion unit comprises a Stirling engine.

18. The energy conversion system of claim 16 wherein the heat to power conversion unit comprises a steam turbine.

19. The energy conversion system of claim 16 wherein the heat driven cooling element comprises an absorption chiller.

20. The energy conversion system of claim 16 wherein data input to the central processing unit includes collector loss vs. operation temperature data.

21. The energy conversion system of claim 16 wherein data input to the central processing unit includes real time sensor from the array of sensors.

22. The energy conversion system of claim 16 wherein data input to the central processing unit includes weather forecast data and calculated solar intensity.

23. The energy conversion system of claim 16 wherein the processing instructions to be executed by the central processing unit calculate flow rates of energy harvested by the energy conversion system distributed to loads to maximize a conversion efficiency defined as percentage of demand.

24. The energy conversion system at claim 16 wherein the processing instructions to be executed by the central processing unit calculate system operating parameters to maximize a conversion efficiency defined as a percentage of total energy demand.

25. The energy conversion system at claim 24 wherein the system operating parameters include collector flow rate.
